(19) United States
(12) Patent Application Publication
(10) Pub. No.: US 2021/0087116 A1
(43) Pub. Date: Mar. 25, 2021

(54) NANOCRYSTALLINE CERAMIC OXIDE BEADS

(71) Applicant: 3M INNOVATIVE PROPERTIES COMPANY, St. Paul, MN (US)

(72) Inventors: Craig W. Lindsay, Minneapolis, MN (US); Susannah C. Clear, Hastings, MN (US); Kenton D. Budd, Woodbury, MN (US); Mahmut Aksit, Woodbury, MN (US); Thomas P. Hedblom, Eagan, MN (US)

(21) Appl. No.: 16/633,926

(22) PCT Filed: Jul. 19, 2018
(86) PCT No.: PCT/IB2018/055395

§ 371 Date: Jan. 24, 2020

Related U.S. Application Data
(60) Provisional application No. 62/538,226, filed on Jul. 28, 2017.

(51) Int. Cl. C04B 35/48; C04B 35/624; C04B 35/64; E01F 9/524

(52) U.S. Cl. CPC C04B 35/481; B82Y 40/00; C04B 35/64; E01F 9/524; C04B 2235/3217; C04B 2235/3227; C04B 2235/3229; C04B 2235/3232; C04B 2235/3244; C04B 2235/3418; C04B 2235/3298; C04B 2235/963; C04B 2235/528; C04B 2235/5454; C04B 2235/549; C04B 2235/9653; C04B 35/624

(57) ABSTRACT

Plurality of nanocrystalline percent by volume crystalline ceramic oxide beads, wherein the nanocrystalline ceramic oxide beads have an average crystallite size up to 250 nm, wherein each bead collectively comprises, on a theoretical oxides basis, at least one of Al₂O₃, SiO₂, TiO₂, or ZrO₂ at least 40 weight percent, and at least 1 weight percent of at least one of a transition metal oxide or at least one Bi₂O₃ or CeO₂, based on the total weight of the nanocrystalline ceramic oxide beads, and are visibly dark and infrared transmissive. The beads are useful, for example, in pavement markings.

### CROSS REFERENCE TO RELATED APPLICATION

This application claims the benefit of U.S. Provisional Patent Application No. 62/538226, filed Jul. 28, 2017, the disclosure of which is incorporated by reference herein in its entirety.

### BACKGROUND

Intelligent systems such as autonomous vehicles have multiple sensing systems and can potentially benefit from materials and markings that provide covert (non-visible) information, in addition to visible cues available to human drivers and pilots.

Beaded retroreflectives are known to provide such covert information. Conventional beads and retroreflectives, however, have deficiencies in durability, refractive index, contrast between visible and non-visible performance, or have undesirable day-time conspicuity.

### SUMMARY

In one aspect, the present disclosure describes a plurality (i.e., at least 100; typically at least 1000) of nanocrystalline (i.e., at least 50 (in some embodiments, at least 55, 60, 65, 70, 75, 80, 85, 90, 95, 96, 97, 98, or even at least 99) percent by volume) crystalline ceramic oxide beads, wherein the nanocrystalline ceramic oxide beads have an average crystallite size up to 250 nm (in some embodiments, up to 200 nm, 150 nm, 100 nm, 75 nm, or up to 50 nm; in some embodiments, in a range from 10 nm to 250 nm, 10 nm to 200 nm, 10 nm to 150 nm, 10 nm to 100 nm, 10 nm to 75 nm, or even 10 nm to 50 nm), wherein each bead collectively comprises, on a theoretical oxides basis, at least 40 (in some embodiments, at least 45, 50, 55, 60, 65, 70, 75, 80, 85, 90, 95, 96, 97, 98, or even up to 99; in some embodiments, in a range from 40 to 99, 50 to 99, 75 to 99, 80 to 99, 85 to 99, or even 95 to 99) weight percent of at least one of Al₂O₃, SiO₂, TiO₂, or ZrO₂, and at least 1 (in some embodiments, at least 2, 3, 4, 5, 10, 15, 20, 25, 30, 35, or even at least 40; in some embodiments, in a range from 1 to 40, 1 to 35, 1 to 30, 1 to 25, 1 to 20, 1 to 15, 1 to 10, 1 to 5, 5 to 40, or even 5 to 20) weight percent of at least one of a transition metal oxide (e.g., on a theoretical oxides basis, oxides of at least one of Cr₂O₃, CoO, CuO, Fe₂O₃, MnO, NiO, or V₂O₅ or at least one of Bi₂O₃ or CeO₂), based on the total weight of the nanocrystalline ceramic oxide beads, and are visibly dark (i.e., retroreflection not greater than 10 (in some embodiments, not greater than 5, 4, 3, 2, or even not greater than 1; in some embodiments, in a range from 1 to 10, or even 1 to 5) percent as compared to the same ceramic oxide beads without the transition metal oxide, Bi₂O₃, and CeO₂ at at least one wavelength in a range from 400 nm to 700 nm and infrared (IR) transmissive (i.e., at least 20; in some embodiments, at least 25, 30, 35, 40, 45, 50, 55, 60, 65, 70, 75, 80, 85, 90, 95, or even at least 100) percent as retroreflective as compared to the same ceramic oxide beads without the transition metal oxide and Bi₂O₃, and CeO₂ at at least one wavelength in a range from greater than 700 nm to 1000 nm as determined by the method described in Example 1).

In this application:

“Ceramic oxide” refers to oxides that are amorphous, glass, crystalline, glass-ceramic, and combinations thereof.

“On a theoretical oxides basis” refers to the theoretical oxide components of a ceramic oxide (e.g., Al₂O₃, SiO₂, TiO₂, ZrO₂, etc.) although the ceramic oxide may or may not actually have those oxide components present. For example, a ceramic oxide comprising Al₂O₃ and SiO₂, may have the Al₂O₃ and SiO₂ in the form of an aluminosilicate.

In another aspect, the present disclosure describes a method of making the nanocrystalline ceramic oxide beads described herein, the method comprising flame heating green ceramic particles to provide the plurality of nanocrystalline ceramic oxide beads.

In another aspect, the present disclosure describes a method of making the nanocrystalline ceramic oxide beads described herein, the method comprising:

forming particles from a sol gel to provide formed particles;

calcining the formed particles to provide calcined particles; and

sintering the calcined particles to provide the plurality of nanocrystalline ceramic oxide beads.

Nanocrystalline ceramic oxide beads described herein are useful, for example, as part of an article (e.g., a pavement marking, a sign, a tag, a fabric, a garment, and another machine readable source of information). Beads described herein provide durable articles such as pavement markings having useful levels of retroreflection in the infrared (IR) wavelength range in combination with low levels of visible reflection and visible retroreflection. Such articles can be detected or read with IR sources and sensors, while providing little or no visible distractions to humans. In some embodiments, such beads exhibit superior mechanical and optical characteristics as compared to conventional glass beads.

### BRIEF DESCRIPTION OF THE DRAWINGS

FIG. 1 is a cross-sectional view of an exemplary retroreflective element.

FIG. 2 is a perspective view of an exemplary pavement marking.

FIG. 3 is a cross-sectional view of an exemplary pavement marking tape.

FIG. 4 is a perspective view of an exemplary pavement marking with beads described herein arranged to form a barcode.

FIG. 4A is an expanded view of a portion of FIG. 4 showing beads described herein arranged to form a barcode.

FIG. 5 shows the effect of changing dopant concentration on wavelength dependent absorbance for CE1 and EX1 Samples 1-4.

FIG. 6 shows Patch brightness values versus dopant concentration for EX1 Samples.

FIG. 7 shows relative retroreflectance versus wavelength for CE1 and EX1 Samples 1-4.

FIG. 8 shows relative retroreflectance versus wavelength for EX2 Samples 5A-5F.

FIG. 9 shows wavelength dependent retroreflective spectra for EX3 Samples 6-9.

FIG. 10 shows wavelength dependent retroreflective spectra for EX4 Samples 10-13.

FIG. 11 shows wavelength dependent retroreflective spectra for EX5 Samples 14, Sample 14 HT900C, CE1, and EX2 Samples 5A and 5F.

### DETAILED DESCRIPTION

Nanocrystalline beads described herein are at least 50 (in some embodiments, at least 55, 60, 65, 70, 75, 80, 85, 90, 95, 96, 97, 98, or even at least 99) percent by volume crystalline ceramic oxide. Volume percent crystallinity can be determined by known methods such as x-ray diffraction or using conventional transmission electron microscopy (TEM) image analysis techniques.

Nanocrystalline beads described herein have an average crystallite size up to 250 nm (in some embodiments, up to 200 nm, 150 nm, 100 nm, 75 nm, or up to 50 nm; in some embodiments, in a range from 10 nm to 250 nm, 10 nm to 200 nm, 10 nm to 150 nm, 10 nm to 100 nm, 10 nm to 75 nm, or even 10 nm to 50 nm). Average crystallite size can be determined using conventional TEM image analysis techniques.

Techniques for making ceramic oxide beads described herein include those known in the art. Exemplary ceramic oxides include, on a theoretical oxides basis, at least one of Al₂O₃, SiO₂, TiO₂, or ZrO₂, and alkaline earth oxides or La₂O₃. Combinations of ceramic oxides include aluminosilicate, lanthanum titanate, alkaline earth titanate, zirconium silicate, zirconium aluminosilicate, and alkaline earth modified zirconium titanium aluminosilicate.

Nanocrystalline beads described herein collectively comprise, on a theoretical oxides basis, at least one of Al₂O₃, SiO₂, TiO₂, or ZrO₂ at least 40 (in some embodiments, at least 45, 50, 55, 60, 65, 70, 75, 80, 85, 90, 95, 96, 97, 98, or even up to 99; in some embodiments, in a range from 40 to 99, 50 to 99, 75 to 99, 80 to 99, 85 to 99, or even 95 to 99) weight percent, based on the total weight of the nanocrystalline ceramic oxide beads. Nanocrystalline beads described herein also comprise, on a theoretical oxides basis, at least 1 (in some embodiments, at least 2, 3, 4, 5, 10, 15, 20, 25, 30, 35, or even at least 40; in some embodiments, in a range from 1 to 40, 1 to 35, 1 to 30, 1 to 25, 1 to 20, 1 to 15, 1 to 10, 1 to 5, 5 to 40, or even 5 to 20) weight percent of at least one of a transition metal oxide (e.g., on a theoretical oxides basis, oxides of at least one of Cr₂O₃, CoO, CuO, Fe₂O₃, MnO, NiO, or V₂O₅ or at least one Bi₂O₃ or CeO₂), based on the total weight of the nanocrystalline ceramic oxide beads. Particularly advantageous ranges for these components include 2 to 15 percent, or 3 to 10 percent by weight of at least one of transition metal oxide. Such ranges tend to provide the desired attenuation of optical retroreflection, while maintaining key characteristics of the base composition such as refractive index, melting behavior, quenching behavior, and crystallization behavior.

In some embodiments, nanocrystalline ceramic oxide beads described herein collectively comprise, on a theoretical oxides basis, at least 80 (in some embodiments, at least 85, 90, 95, 96, 97, 98, or even 99) percent by weight SiO₂ and ZrO₂, based on the total weight of the nanocrystalline ceramic oxide beads. Zirconium silicate beads can be made by techniques known in the art such as sol-gel. In some embodiments, the beads are greater than 100 micrometers in diameter.

In some embodiments, nanocrystalline ceramic oxide beads described herein collectively comprise, on a theoretical oxides basis, at least 80 (in some embodiments, at least 85, 90, 95, 96, 97, 98, or even 99) percent by weight Al₂O₃, SiO₂, and ZrO₂, based on the total weight of the nanocrystalline ceramic oxide beads. Zirconium aluminosilicate beads can be made, for example, by techniques known in the art such as sol-gel and flame forming.

In some embodiments, nanocrystalline ceramic oxide beads described herein collectively comprise, on a theoretical oxides basis, at least 70 (in some embodiments, at least 75, 80, 85, 90, 95, 96, 97, 98, or even 99) percent weight Al₂O₃, SiO₂, TiO₂, and ZrO₂, based on the total weight of the nanocrystalline ceramic oxide beads. Such beads can be made, for example, by techniques known in the art such as flame forming.

In some embodiments, nanocrystalline ceramic oxide beads described herein collectively comprise, on a theoretical oxides basis, at least 60 (in some embodiments, at least 65, 70, 75, 80, 85, 90, 95, 96, 97, 98, or even 99) percent by weight TiO₂ and ZrO₂ based on the total weight of the nanocrystalline ceramic oxide beads. Such beads can be made by techniques known in the art such as flame forming. In some embodiments, such beads have a refractive index greater than 2.2 (in some embodiments, greater than 2.3, or even greater than 2.4). In some embodiments, such beads exhibit retroreflection when submerged in water.

In some embodiments, nanocrystalline ceramic oxide beads described herein collectively comprise, on a theoretical oxides basis, at least 60 (in some embodiments, at least 65, 70, 75, 80, 85, 90, 95, 96, 97, 98, or even 99) percent by weight TiO₂, based on the total weight of the nanocrystalline ceramic oxide beads. Such beads can be made by techniques known in the art such as flame forming. In some embodiments, such beads have a refractive index greater than 2.2 (in some embodiments, greater than 2.3, or even greater than 2.4). In some embodiments, such beads exhibit retroreflection when submerged in water.

In some embodiments, nanocrystalline ceramic oxide beads described herein further collectively comprise of at least 5 (in some embodiments, at least 10, 15, 20, 25, or even up to 30; in some embodiments, in a range from 5 to 30) percent by weight alkaline earth oxide, based on the total weight of the nanocrystalline ceramic oxide beads. Alkaline earth oxide provides a useful flux for flame forming without significantly compromising the chemical durability of the beads.

In some embodiments, nanocrystalline ceramic oxide beads described herein further collectively comprise, on a theoretical oxides basis, at least 5 (in some embodiments, at least 10, 15, 20, 25, 30, 35, or even up to 40) percent by weight La₂O₃, based on the total weight of the nanocrystalline ceramic oxide beads. Lanthanum oxide provides useful fluxing and high refractive index.

Nanocrystalline beads described herein are visibly dark (i.e., retroreflection not greater than 10 (in some embodiments, not greater than 5, 4, 3, 2, or even not greater than 1; in some embodiments, in a range from 1 to 10, or even 1 to 5) percent as compared to the same ceramic oxide beads without the transition metal oxide, Bi₂O₃, and CeO₂ at at least one wavelength in a range from 400 nm to 700 nm and infrared (IR) transmissive (i.e., at least 20; in some embodiments, at least 25, 30, 35, 40, 45, 50, 55, 60, 65, 70, 75, 80, 85, 90, 95, or even at least 100) percent as retroreflective as compared to the same ceramic oxide beads without the transition metal oxide and Bi₂O₃, and CeO₂ at at least one wavelength in a range from greater than 700 nm to 1000 nm. Retroreflected intensity as a function of wavelength is described in the Example 1 below.

In some embodiments, nanocrystalline ceramic oxide beads described herein are sized in a range from 20 micrometers to 2000 micrometers (in some embodiments, in a range from 20 micrometers to 1000 micrometers, 20 micrometers to 500 micrometers, 20 micrometers to 250 micrometers, 50 micrometers to 250 micrometers, or even 75 micrometers to 150 micrometers).

In some embodiments, nanocrystalline ceramic oxide beads described herein have an average crush strength of at least 100 (in some embodiments, at least 200, 300, 400, 500, 600, or even at least 700) MPa. The average crush strength of nanocrystalline ceramic oxide beads described herein can be determined according to the test procedure in U.S. Pat. No. 4,772,511 (Wood), the disclosure of which is incorporated by reference. The rush resistance of microspheres is measured as described in the Examples below.

In some embodiments, nanocrystalline ceramic oxide beads described herein have a refractive index at 900 nm of at least 1.6 (in some embodiments, 1.7, 1.8, 1.9, 2.0, 2.1, 2.2, 2.3, or even at least 2.4). The refractive index at 900 nm of nanocrystalline ceramic oxide beads described herein can be determined as described in T. Yamaguchi, “Refractive Index Measurement of High Refractive Index Beads,” Applied Optics, Vol. 14, No. 5, pp. 1111-1115 (1975), the disclosure of which is incorporated herein by reference).

In some embodiments, nanocrystalline ceramic oxide beads described herein have a density in a range from 3 g/cm³ to 6 g/cm³. The density of the nanocrystalline ceramic oxide beads described herein can be determined by techniques known in the art, including helium pycnometry, or simple weight and volume measurements by water displacement in a graduated cylinder.

In some embodiments, nanocrystalline ceramic oxide beads described herein have an outer surface with at least one layer (in some embodiments, two, three, or more layers) of a ceramic oxide thereon. In some embodiments, the layer of ceramic oxide comprises, on a theoretical oxides basis, at least one of TiO₂ or SiO₂. Layers comprising TiO₂ or SiO₂ can be used, for example, to provide integral specular reflectors, antireflection layers, and can be tuned to reflect or antireflect a desired wavelength more strongly than other wavelengths.

In some embodiments, the layer of ceramic oxide has an average thickness of up to 1000 (in some embodiments, up to 750, 500, 250, 200, or even up to 150; in some embodiments, in a range from 50 to 250, or even 50 to 150) nm. In some embodiments, the layer of ceramic oxide has an average thickness that is within +30% of an optical ¼ wave coating for 900 nm light. Coating thickness can be determined using scanning electrom microscopy (SEM) or transmission electron mocroscopy (TEM) of fractured beads, or by coating visibly transmissive beads and observing retroreflected color (as described in the U.S. Pat. No. 6,978,896 (Budd et al.), the disclosure of which is incorporated herein by reference). Quarter wavelength coatings have thickness equal to desired wavelength/(4×refractive index of the coating). A quarter wavelength of a coating intermediate between bead refractive index (RI) and air (e.g., a silica coating with RI=1.4 on a bead with RI=1.9) provides front surface antireflection. A stack of relatively high RI and low RI quarterwave coatings (e.g., amorphous silica—amorphous titania—amorphous silica with RI=1.4, 2.2, 1.4 respectively) provides a useful integral reflector for nonreflectorized, nonpigmented, or absorbing pigmented articles.

In some embodiments of the articles, at least a portion of a plurality of beads described herein, which may be or include coated beads described herein, are present on a major surface of a transparent (i.e., polymer) substrate and/or at least partially embedded into the transparent substrate. Exemplary transparent substrates include crosslinked polymer (e.g., polyurethanes, polyureas, epoxies, and polyesters) and thermoplastic (e.g., ethylene acrylic acid copolymers, ethylene methacrylic acid copolymers and their ionomers, and polyesters) layers. Transparent substrates can result in articles with low daylight conspicuity.

In some embodiments of the articles, at least a portion of a plurality of beads described herein, which may be or include coated beads described herein, are present on a major surface of a translucent (i.e., polymer) substrate and/or at least partially embedded into the translucent substrate. Exemplary translucent substrates include semicrystalline polymers. Translucent substrates can result in articles with low daylight conspicuity.

In some embodiments of the articles, at least a portion of a plurality of beads described herein, which may be or include coated beads described herein, are present on a major surface of an opaque (i.e., pigment filled polymer) substrate and/or at least partially embedded into the opaque substrate. Exemplary opaque substrates include crosslinked (e.g., polyurethanes, polyureas, epoxies, and polyesters) coatings and thermoplastic (e.g., ethylene acrylic acid copolymers, ethylene methacrylic acid copolymers and their ionomers, and polyesters) layers. Opaque substrates can be pigmented substrates, which can provide useful levels of retroreflection without other reflectors. Opaque substrates can have low conspicuity with visibly dark pigments or pigmented articles that match local background in color and intensity. In some embodiments of the articles, the substrate further comprises a pigment (e.g., a pearlescent pigment). In some embodiments, the pigment absorbs visible light but reflects infared (IR) light. Exemplary pigments include titania, an infrared (IR) reflective black pigment (available, for example, under the trade designation “BLACK ECLIPSE 10202” from Ferro Corporation, Cleveland, Ohio), and pearlescent pigments. Exemplary pigments are available, for example, under the trade designation “GLACIER EXTERIOR SILK WHITE EH 2112” from BASF Corporation, Florham Park, N.J.

In some embodiments of the articles, at least a portion of the plurality of beads, which may be or include coated beads, are arranged on a major surface of a substrate and/or at least partially embedded into the substrate to exhibit at least one pattern (e.g., barcode). In some embodiments of the articles, at least a portion of the plurality of beads, which may be or include coated beads, are arranged on a major surface of a substrate and/or at least partially embedded into the substrate to exhibit at least one alphanumeric.

In some embodiments of the articles, there is at least one further plurality of beads that is different (e.g., different size, composition, microstructure between beads and/or coatings on beads) than the first plurality of beads. Articles comprising combinations of beads can have more complex patterns than simply beaded and nonbeaded areas (e.g., high and low retroreflectivity, different levels of wavelength contrast, different combinations of visible versus IR patterns, etc.).

In another aspect, the present disclosure describes a method of making the nanocrystalline ceramic oxide beads described herein, the method comprising flame heating green ceramic particles to provide the plurality of nanocrystalline ceramic oxide beads (see, e.g., U.S. Pat. No. 7,579,293 (Frey et al.), the disclosure of which is incorporated herein by reference (see e.g., col. 10, line 45 to col. 13, line 64)).

In another aspect, the present disclosure describes a method of making the nanocrystalline ceramic oxide beads described herein, the method comprising:

forming particles from a sol gel to provide formed particles;

calcining the formed particles to provide calcined particles; and

sintering the calcined particles to provide the plurality of nanocrystalline ceramic oxide beads (see e.g., U.S. Pat. No. 4,772,511 (Wood et al.), the disclosure of which is incorporated herein by reference (see in particular, for example, col. 5, line 41 to col. 7, line 58)).

In some embodiments, methods described herein for making beads further comprise heat treating the plurality of nanocrystalline ceramic oxide beads (see, e.g., U.S. Pat. No. 7,579,293 (Frey et al.), the disclosure of which is incorporated herein by reference (see e.g., at col. 13, lines 24-59)).

Some embodiments of nanocrystalline ceramic oxide beads described herein are useful, for example, in beaded retroreflective articles (e.g., a pavement marking security articles, safety clothing, signage, and license plates). Nanocrystallinity can impart high durability and high refractive index which are especially useful for road durability, wash durability, chemical durability, wet reflectivity, and constructions where beads are immersed in a matrix.

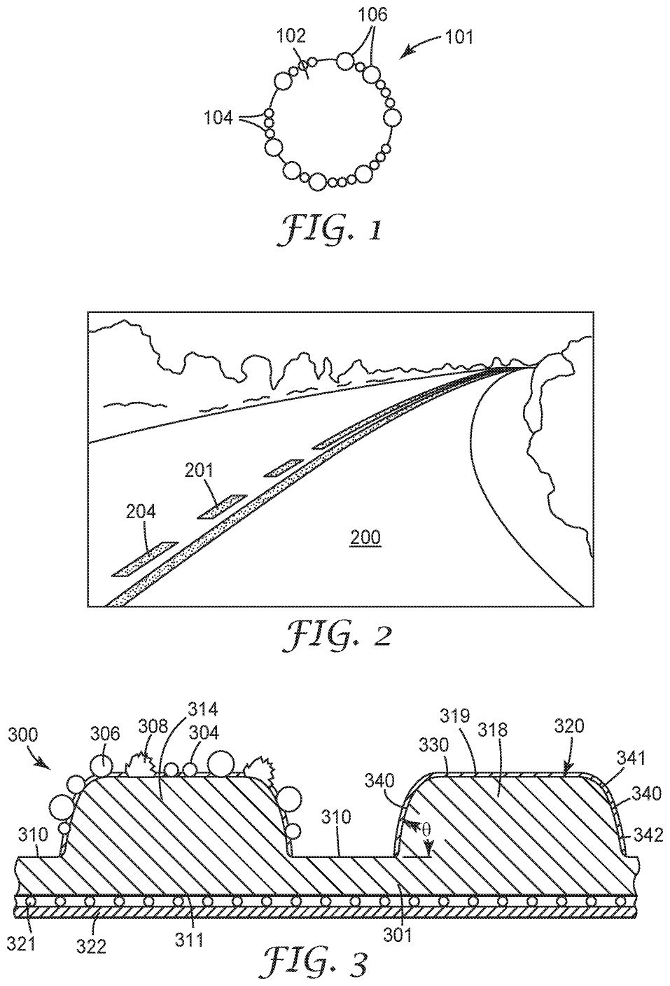

Referring to FIG. 1, retroreflective element 101 comprises nanocrystalline ceramic oxide beads described herein 104 alone or in combination with other beads (e.g., other nanocrystalline ceramic oxide beads described herein different (e.g., different composition and/or crystal structure) than nanocrystalline ceramic oxide beads 104 and/or different beads known in the art) 106 partially embedded in the surface of core 102. The core is typically substantially larger than the beads. In some embodiments, the average core diameter is in a range from 0.2 millimeter to about 10 millimeters.

In some embodiments, the beads and/or reflective elements are employed in liquid-applied marking (e.g., pavement) applications. For example, referring to FIG. 2, beads described herein 204 and/or reflective elements 201 are sequentially or concurrently dropped onto a liquefied binder or compounded within a liquefied binder that is provided on pavement surface 200.

In some embodiments, beads and/or reflective elements are employed in retroreflective sheeting including exposed lens, encapsulated lens, embedded lens, or enclosed lens sheeting. Representative pavement-marking sheet material (tapes), which can be modified to include beads described herein, are described, for example, in U.S. Pat. No. 4,248,932 (Tung et al.), U.S. Pat. No. 4,988,555 (Hedblom), U.S. Pat. No. 5,227,221 (Hedblom), U.S. Pat. No. 5,777,791 (Hedblom), and U.S. Pat. No. 6,365,262 (Hedblom).

Patterned retroreflective (e.g., pavement) markings advantageously provide vertical surfaces (e.g., defined by protrusions) in which the beads are partially embedded. Because the light source usually strikes a pavement marker at high entrance angles, the vertical surfaces, containing embedded beads, provide for more effective retroreflection. Vertical surfaces also tend to keep the beads out of the water during rainy periods thereby improving retroreflective performance.

For example, FIG. 3 shows exemplary patterned pavement marker 300 comprising (e.g., resilient) polymeric base sheet 301 and plurality of protrusions 314. For illustrative purposes, only one protrusion 314 has been covered with beads and antiskid particles. Base sheet 301 has first (e.g., front) surface 310 from which protrusions 314 extend, and second (e.g., back) surface 311. Base sheet 301 is typically about 1 millimeter (0.04 inch) thick, but may be of another dimension if desired. Optionally, marker 320 may further comprise scrim 321 and/or adhesive layer 322 on back surface 311. Protrusion 314 has third (e.g., top) surface 330, fifth (e.g., side) surfaces 340, and in an illustrative embodiment is about 2 millimeters (0.08 inch) high. Protrusions with other dimensions may be used if desired. As shown, fifth surfaces 340 meet top surface 330 at rounded top portions 341. In some embodiments, fifth surfaces 340 form an angle θ of about 70° at the intersection of first surface 310 with lower portion 342 of side surfaces 340. Protrusion 318 is coated with pigment-containing binder layer 319. Embedded in binder layer 319 are a plurality of nanocrystalline ceramic oxide beads described herein 304 and optional plurality of second beads 306. Optionally, antiskid particles 308 may be embedded in binder layer 319.

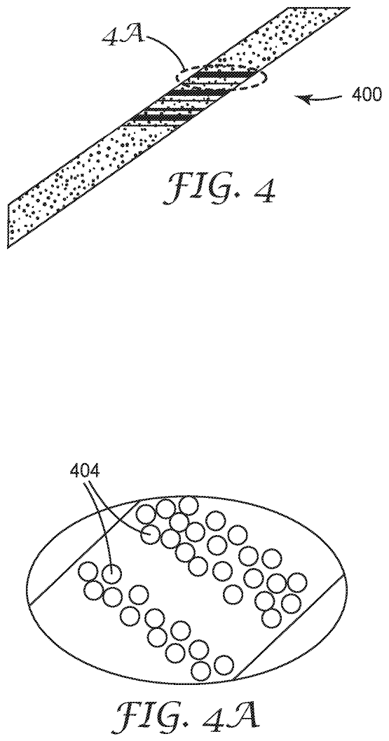

Referring to FIGS. 4 and 4A, exemplary pavement marking 400 has nanocrystalline beads described herein 404 arranged to form a bar code.

Nanocrystalline ceramic oxide beads described herein are also useful in vehicle paints and films. Dark vehicle surfaces often provide insufficient reflected light to light detection and ranging (LIDAR) systems. Even relatively low levels of retroreflection can be substantially stronger than, for example, diffuse reflection from a dark surface. Hence, relatively low concentrations of nanocrystalline ceramic oxide beads described herein can be incorporated into base coat paints, clear coat paints, and automotive films (e.g., films protecting painted surfaces) with desirable conspicuity. In some embodiments, the beads are fully buried in a paint or film and have a refractive index of at least 2.2 (in some embodiments, at least 2.3, 2.4, or even at least 2.5). In some embodiments, the beads have an average diameter not greater than 50 (in some embodiments, not greater than 40, 30, or even 20) micrometers. In other embodiments, the beads are partially exposed or covered by a conformal paint or film material. Paints and films with visibly adsorbing IR transparent beads provide LIDAR detectability with desirably low levels of visible retroreflection.

Dark surfaces are surfaces having a reflectivity not greater than 20% (at or over a given wavelength range) of that for a diffuse white standard with an L* value of at least 90% (at or over the same wavelength range). “Dark” is determined as described in the Examples. All descriptions and embodiments referring to being dark are intended to mean a surface is dark in the absence of any retroreflective microspheres. A dark surface further comprising retroreflective microspheres can have greater reflectance and retroreflectivity than an otherwise dark surface described herein.

In some embodiments, a dark surface comprises a paint, wherein the paint comprises at least one of beads or coated beads described herein, and wherein the dark surface has a retroreflectivity at 900 nm that is at least twice that of the same surface and paint without the beads or coated beads. In some embodiments, the beads or coated beads are fully buried in the paint. In some embodiments, the beads or coated beads are partially embedded in the paint. In some embodiments, the paint includes a pigmented layer(s), and wherein at least some of said beads or coated beads are in the pigmented layer(s). In some embodiments, the paint includes an unpigmented layer(s), and wherein at least some of said beads or coated beads are in the unpigmented layer(s). In some embodiments, the beads or coated beads have an average diameter not greater than 50 (in some embodiments, not greater than 40, 30, 25, or even not greater than 20) micrometers.

In some embodiments, a dark surface comprises a film (e.g., a polymer film), wherein the film comprises at least one of beads or coated beads described herein, and wherein the dark surface comprising a film having a retroreflectivity at 900 nm that is at least twice that of the same surface and film without said beads or coated beads. In some embodiments, the beads or coated beads are fully buried in the film. In some embodiments, the beads or coated beads are partially embedded in the film. In some embodiments, the film includes a pigmented layer(s), and wherein at least some of said beads or coated beads are in the pigmented layer(s). In some embodiments, the film includes an unpigmented layer(s), and wherein at least some of said beads or coated beads are in the unpigmented layer(s). In some embodiments, the beads or coated beads have an average diameter not greater than 50 (in some embodiments, not greater than 40, 30, 25, or even not greater than 20) micrometers.

### Exemplary Embodiments

1A. A plurality (i.e., at least 100; typically at least 1000) of nanocrystalline (i.e., at least 50 (in some embodiments, at least 55, 60, 65, 70, 75, 80, 85, 90, 95, 96, 97, 98, or even at least 99) percent by volume crystalline ceramic oxide) beads, wherein the nanocrystalline ceramic oxide beads have an average crystallite size up to 250 nm (in some embodiments, up to 200 nm, 150 nm, 100 nm, 75 nm, or up to 50 nm; in some embodiments, in a range from 10 nm to 250 nm, 10 nm to 200 nm, 10 nm to 150 nm, 10 nm to 100 nm, 10 nm to 75 nm, or even 10 nm to 50 nm), wherein each bead collectively comprises, on a theoretical oxides basis, at least 40 (in some embodiments, at least 45, 50, 55, 60, 65, 70, 75, 80, 85, 90, 95, 96, 97, 98, or even up to 99; in some embodiments, in a range from 40 to 99, 50 to 99, 75 to 99, 80 to 99, 85 to 99, or even 95 to 99) weight percent of at least one of Al₂O₃, SiO₂, TiO₂, or ZrO₂, and at least 1 (in some embodiments, at least 2, 3, 4, 5, 10, 15, 20, 25, 30, 35, or even at least 40; in some embodiments, in a range from 1 to 40, 1 to 35, 1 to 30, 1 to 25, 1 to 20, 1 to 15, 1 to 10, 1 to 5, 5 to 40, or even 5 to 20) weight percent of at least one of a transition metal oxide (e.g., on a theoretical oxides basis, oxides of at least one of Cr₂O₃, CoO, CuO, Fe₂O₃, MnO, NiO, or V₂O₅ or at least one Bi₂O₃ or CeO₂), based on the total weight of the nanocrystalline ceramic oxide beads, and are visibly dark (i.e., retroreflection not greater than 10 (in some embodiments, not greater than 5, 4, 3, 2, or even not greater than 1; in some embodiments, in a range from 1 to 10, or even 1 to 5) percent as compared to the same ceramic oxide beads without the transition metal oxide, Bi₂O₃, and CeO₂ at at least one wavelength in a range from 400 nm to 700 nm and infrared (IR) transmissive (i.e., at least 20; in some embodiments, at least 25, 30, 35, 40, 45, 50, 55, 60, 65, 70, 75, 80, 85, 90, 95, or even at least 100) percent as retroreflective as compared to the same ceramic oxide beads without the transition metal oxide and Bi₂O₃, and CeO₂ at at least one wavelength in a range from greater than 700 nm to 1000 nm as determined by the method described in Example 1).
2A. The plurality of nanocrystalline ceramic oxide beads of Exemplary Embodiment 1A collectively comprising, on a theoretical oxides basis, at least 80 (in some embodiments, at least 85, 90, 95, 96, 97, 98, or even 99) percent by weight SiO₂ and ZrO₂, based on the total weight of the nanocrystalline ceramic oxide beads.
3A. The plurality of nanocrystalline ceramic oxide beads of Exemplary Embodiment 1A collectively comprising, on a theoretical oxides basis, at least 80 (in some embodiments, at least 85, 90, 95, 96, 97, 98, or even 99) percent by weight Al₂O₃, SiO₂, and ZrO₂, based on the total weight of the nanocrystalline ceramic oxide beads.
4A. The plurality of nanocrystalline ceramic oxide beads of Exemplary Embodiment 1A collectively comprising, on a theoretical oxides basis, at least 70 (in some embodiments, at least 75, 80, 85, 90, 95, 96, 97, 98, or even 99) percent weight Al₂O₃, SiO₂, TiO2, and ZrO₂, based on the total weight of the nanocrystalline ceramic oxide beads.
5A. The plurality of nanocrystalline ceramic oxide beads of Exemplary Embodiment 1A collectively comprising, on a theoretical oxides basis, at least 60 (in some embodiments, at least 65, 70, 75, 80, 85, 90, 95, 96, 97, 98, or even 99) percent by weight TiO₂ and ZrO₂, based on the total weight of the nanocrystalline ceramic oxide beads.
6A. The plurality of nanocrystalline ceramic oxide beads of Exemplary Embodiment 1A collectively comprising, on a theoretical oxides basis, at least 60 (in some embodiments, at least 65, 70, 75, 80, 85, 90, 95, 96, 97, 98, or even 99) percent by weight TiO₂, based on the total weight of the nanocrystalline ceramic oxide beads.
7A. The plurality of nanocrystalline ceramic oxide beads of any preceding A Exemplary Embodiment, further comprising collectively of at least 5 (in some embodiments, at least 10, 15, 20, 25, or even up to 30; in some embodiments, in a range from 5 to 30) percent by weight alkaline earth oxide, based on the total weight of the nanocrystalline ceramic oxide beads.
8A. The plurality of nanocrystalline ceramic oxide beads of any preceding A Exemplary Embodiment, collectively further comprising at least 5 (in some embodiments, at least 10, 15, 20, 25, 30, 35, or even up to 40) percent by weight La₂O₃, based on the total weight of the nanocrystalline ceramic oxide beads.
9A. The plurality of nanocrystalline ceramic oxide beads of any preceding A Exemplary Embodiment, wherein the beads are sized in a range from 20 micrometers to 2000 micrometers (in some embodiments, in a range from 20 micrometers to 1000 micrometers, 20 micrometers to 500 micrometers, 20 micrometers to 250 micrometers, 50 micrometers to 250 micrometers, or even 75 micrometers to 150 micrometers).
10A. The plurality of nanocrystalline ceramic oxide beads of any preceding A Exemplary Embodiment, wherein the beads have an average crush strength of at least 200 (in some embodiments, at least 300, 400, 500, 600, or even at least 700) MPa.
11A. The plurality of nanocrystalline ceramic oxide beads of any preceding A Exemplary Embodiment, wherein the beads have a refractive index at 900 nm of at least 1.6 (in some embodiments, 1.7, 1.8, 1.9, 2.0, 2.1, 2.2, 2.3, or even at least 2.4).
12A. The plurality of nanocrystalline ceramic oxide beads of any preceding A Exemplary Embodiment, wherein the beads have a density in a range from 3 g/cm³ to 6 g/cm³.
13A. The plurality of nanocrystalline ceramic oxide beads of any preceding A Exemplary Embodiment, wherein the beads are retroreflective in infrared.
1B. A plurality of coated beads comprising the nanocrystalline ceramic oxide beads of any preceding A Exemplary Embodiment, wherein the nanocrystalline ceramic oxide beads have an outer surface with at least one layer (in some embodiments, two, three, or more layers) of a ceramic oxide thereon.
2B. The plurality of coated beads of Exemplary Embodiment 1B, wherein the layer of ceramic oxide comprises, on a theoretical oxides basis, at least one of TiO₂ or SiO₂.
3B. The plurality of coated beads of any preceding B Exemplary Embodiment, wherein the layer of ceramic oxide has an average thickness of up to 1000 (in some embodiments, up to 750, 500, 250, 200, or even up to 150; in some embodiments, in a range from 50 to 250, or even 50 to 150) nm.
4B. The plurality of coated beads of either Exemplary Embodiment 1B or 2B, wherein the layer of ceramic oxide has an average thickness that is within ±30% of an optical ¼ wave coating for 900 nm light.
5B. The plurality of coated beads of any preceding B Exemplary Embodiment, wherein the coated beads are visibly dark (i.e., retroreflection not greater than 10 (in some embodiments, not greater than 5, 4, 3, 2, or even not greater than 1; in some embodiments, in a range from 1 to 10, or even 1 to 5) percent as compared to the same ceramic oxide beads without the transition metal oxide, Bi₂O₃, and CeO₂ at at least one wavelength in a range from 400 nm to 700 nm and infrared (IR) transmissive (i.e., at least 20; in some embodiments, at least 25, 30, 35, 40, 45, 50, 55, 60, 65, 70, 75, 80, 85, 90, 95, or even at least 100) percent as retroreflective as compared to the same ceramic oxide beads without the transition metal oxide and Bi₂O₃, and CeO₂ at at least one wavelength in a range from greater than 700 nm to 1000 nm as determined by the method described in Example 1).
1C. An article comprising the plurality of beads of any A Exemplary Embodiment or coated beads of any B Exemplary Embodiment.
2C. The article of Exemplary Embodiment 1C, wherein at least a portion of the plurality of beads is present on a major surface of a transparent substrate.
3C. The article of Exemplary Embodiment 2C, wherein a portion of the plurality of beads is at least partially embedded into the transparent substrate.
4C. The article of Exemplary Embodiment 1C, wherein at least a portion of the plurality of beads is at least partially embedded into a transparent substrate.
5C. The article of Exemplary Embodiment 1C, wherein at least a portion of the plurality of beads is present on a major surface of a translucent substrate.
6C. The article of Exemplary Embodiment 5C, wherein a portion of the plurality of beads is at least partially embedded into the translucent substrate.
7C. The article of Exemplary Embodiment 1C, wherein at least a portion of the plurality of beads is at least partially embedded into a translucent substrate.
8C. The article of Exemplary Embodiment 1C, wherein at least a portion of the plurality of beads is present on a major surface of an opaque substrate.
9C. The article of Exemplary Embodiment 8C, wherein a portion of the plurality of beads is at least partially embedded into an opaque substrate.
10C. The article of Exemplary Embodiment 1C, wherein at least a portion of the plurality of beads is at least partially embedded into an opaque substrate.
11C. The article of any preceding C Exemplary Embodiment further comprising a pigment (e.g., a pearlescent pigment).
12C. The article of Exemplary Embodiment 11C, wherein the pigment absorbs visible light but reflects infared (IR) light.
13C. The article of any of Exemplary Embodiments 2C to 12C, wherein at least a portion of the plurality of beads is arranged to exhibit at least one pattern (e.g., barcode).
14C. The article of any of Exemplary Embodiments 2C to 13C, wherein at least a portion of the plurality of beads is arranged to exhibit at least one alphanumeric.
15C. The article of any preceding C Exemplary Embodiment that is a pavement marking.
D. Exemplary Embodiments are the same as the C Exemplary Embodiments except the beads are the coated beads of any B Exemplary Embodiment.
E. Exemplary Embodiments are the same as the C Exemplary Embodiments except further comprising the coated beads of any B Exemplary Embodiment.
F. Exemplary Embodiments are the same as any of the B, C, D, or E Exemplary Embodiments further comprising at least one of a plurality of beads or a plurality of coated beads of any preceding Exemplary Embodiment different than the plurality of beads and/or coated beads present.
1G. A paint comprising a dark major surface, the paint layer comprising at least one of beads of any A Exemplary Embodiment or coated beads of any B Exemplary Embodiment, and wherein the dark major surface has a retroreflectivity at 900 nm that is at least twice that of the same surface without said beads or coated beads being present.
2G. The dark surface of Exemplary Embodiment 1G, wherein said beads or coated beads are fully buried in the paint.
3G. The dark surface of Exemplary Embodiment 1G, wherein said beads or coated beads are partially embedded in the paint.
4G. The dark surface of any preceding G Exemplary Embodiment, wherein the paint includes a pigmented layer, and wherein at least some of said beads or coated beads are in the pigmented layer.
5G. The dark surface of any preceding G Exemplary Embodiment, wherein the paint includes an unpigmented layer, and wherein at least some of said beads or coated beads are in the unpigmented layer.
6G. The dark surface of any preceding G Exemplary Embodiment, wherein the said beads or coated beads have an average diameter not greater than 50 (in some embodiments, not greater than 40, 30, 25, or even not greater than 20) micrometers.
1H. A film comprising a dark major surface, the film comprising at least one of beads of any A Exemplary Embodiment or coated beads of any B Exemplary Embodiment, and wherein the dark major surface has a retroreflectivity at 900 nm that is at least twice that the same surface without said beads or coated beads being present.
2H. The dark surface of Exemplary Embodiment 1H, wherein said beads or coated beads are fully buried in the film.
3H. The dark surface of Exemplary Embodiment 1H, wherein said beads or coated beads are partially embedded in the film.
4H. The dark surface of any preceding H Exemplary Embodiment, wherein the film includes a pigmented layer, and wherein at least some of said beads or coated beads are in the pigmented layer.
5H. The dark surface of any preceding H Exemplary Embodiment, wherein the film includes an unpigmented layer, and wherein at least some of said beads or coated beads are in the unpigmented layer.
6H. The dark surface of any preceding H Exemplary Embodiment, wherein the said beads or coated beads have an average diameter not greater than 50 (in some embodiments, not greater than 40, 30, 25, or even not greater than 20) micrometers.
11. A method of making the nanocrystalline ceramic oxide beads of any preceding A Exemplary Embodiment, the method comprising flame heating green ceramic particles to provide the plurality of nanocrystalline ceramic oxide beads.
21. The method of Exemplary Embodiment 11, further comprising heat treating the plurality of nanocrystalline ceramic oxide beads.
1J. A method of making the nanocrystalline ceramic oxide beads of any preceding A Exemplary

Embodiment, the method comprising:

forming particles from a sol gel to provide formed particles;

calcining the formed particles to provide calcined particles; and

sintering the calcined particles to provide the plurality of nanocrystalline ceramic oxide beads.
2J. The method of Exemplary Embodiment 1J, further comprising heat treating the plurality of nanocrystalline ceramic oxide beads.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, St. Louis, MO, or may be synthesized by conventional methods.

These abbreviations are used in the following examples: cc=cubic centimeters; phr=parts per hundred rubber; g=grams, min.=minutes, h=hour, ° C.=degrees Celsius, MPa=megapascals, and N-m=Newton-meter.

The raw materials used are listed in Table 1, below.

TABLE 1

| Abbreviation | Material | Source |
|---|---|---|
| Al₂O₃ | Aluminum (III) Oxide (Al₂O₃) | Obtained from Alcoa Chemicals, |
| | | Point Comfort, TX, under trade |
| | | designation “A16-SG” |
| TiO₂ | Titanium (IV) Oxide (TiO2) | Obtained from Kronos Worldwide, |
| | | Inc., Dallas, TX, under trade |
| | | designation “KRONOS 1000” |
| ZrO₂ | Zirconium (IV) Oxide (ZrO₂), 1.6 | Obtained from Z-Tech LLC, Bow, |
| | micrometer average particle size | NH, under trade designation “CF- |
| | | PLUS-HM” |
| ZrSiO₄ | Zircon flour (ZrSiO₄) | Obtained from Trebol, Andrews, |
| | | SC, under trade designation |
| | | “ULTROX” |
| Talc | Magnesium silicate mono hydrate | Obtained from Alfa Aesar, Ward |
| | (Talc) (3MgO•4SiO₂•H₂O) | Hill, MA |
| CaCO₃ | Calcium Carbonate (CaCO₃) | Obtained from Alfa Aesar |
| Cell gum | Sodium carboxymethylcellulose | Obtained from Hercules |
| | (Cell Gum) | Incorporated, Aqualon Division, |
| | | Wilmington, DE, under trade |
| | | designation “7L1T” |
| Sodium | Sodium polymethacrylate | Obtained from Geo Specialty |
| polymethacrylate | solution | Chemicals, Ambler, PA, under |
| solution | | trade designation “DAXAD 30” |
| CeO₂ | Cerium (IV) oxide (CeO₂) | Obtained from Sigma Aldrich, St. |
| | | Louis, MO |
| CE(OH)₂ | Cobalt (II) hydroxide (CE(OH)₂) | Obtained from Alfa Aesar |
| Fe₂O₃ | Iron (III) oxide (Fe₂O₃) | Obtained from Alfa Aesar |
| Cr₂O₃ | Chromium (III) oxide (Cr₂O₃) | Obtained from Alfa Aesar |
| MnO₂ | Manganese (IV) oxide (MnO₂) | Obtained from Alfa Aesar |
| La₂O₃ | Lanthanum (III) oxide (La₂O₃) | Obtained from China Minmetals, |
| | | Beijing, P.R. China |
| BaCO₃ | Barium carbonate (BaCO₃) | Obtained from CPC, Cartersville, |
| | | GA |
| SrCO₃ | Strontium carbonate (SrCO₃) | Obtained from Alfa Aesar |

### Preparative Example 1 (PE1)

Metal-oxide raw material powder mixtures were produced by making a master batch aqueous suspension of Co(OH)₂, Cr₂O₃, and MnO₂ with sodium cell gum. The batching for Preparative Example 1 is shown in Table 2, below.

TABLE 2

| Raw Materials | Amount, grams |
|---|---|
| Water | 1000.0 |
| Co(OH)₂ | 500.0 |
| MnO₂ | 600.3 |
| Cr₂O₃ | 99.8 |
| Cell Gum | 18.0 |
| Sodium | 24.0 |
| polymethacrylate | |
| solution | |

The cell gum was added to the water very slowly first and fully dissolved with aggressive high shear mixing. The sodium polymethacrylate solution was added before the powders were added individually. The mixture was ball milled in a 1.5 gallon (5.7 liter) alumina fortified grinding jar (obtained from U.S. Stoneware East Palestine, OH, under the trade designation “ROALAX”) with 1 cm cylindrical alumina media (obtained from U.S. Stoneware under the trade designation “BURUNDUM”) half filling the jar for 24 hours to make a homogeneous suspension.

### Comparative Example 1 (CE1)

A comparative un-doped base glass composition was made by the same slurry processing technique as described for PE1, but with the formulation shown in Table 3, below.

TABLE 3

| Raw Materials | Amount, grams |
|---|---|
| Water | 962.3 |
| TiO₂ | 513.8 |
| Al₂O₃ | 541.2 |
| Talc | 267.0 |
| ZrSiO₄ | 338.7 |
| CaCO₃ | 310.9 |
| Cell Gum | 23.7 |
| sodium | 39.4 |
| polymethacrylate | |
| solution | |

### Example 1 (EX1)

PE1 and CE1 compositions were blended under high shear using a high shear mixer (obtained from Silverson, East Longmeadow, Mass., under the trade designation “SILVERSON L5M-A”) equipped with a 1 inch (2.5 cm) mixing head set a 7500 RPM for more than 1 hour at 4 different concentration ratios as shown in Table 4, below.

TABLE 4

| Slurry, grams | Sample 1 | Sample 2 | Sample 3 | Sample 4 |
|---|---|---|---|---|
| CE1 | 3000 | 3000 | 3000 | 3000 |
| PE1 | 126 | 260.7 | 404.9 | 559.8 |
| Weight % Dopant | 3.2 | 6.4 | 9.6 | 12.8 |

Molded precursor green particles were made from slurry by following the general teachings of U.S. Pat. No. 8,701,441 (Kramlich et. al.), which is incorporated herein by reference.

The molded precursor green particles of CE1 and Samples 1-4 were processed through a flame former to generate glass beads. The flame former was run with natural gas (172.4 SLPM) and air (1375 SLPM) as the primary components with supplemental oxygen (73.3 SLPM) added to generate a 25% oxygen flame. The first pass feed rate of material into the burner was 2.3 lbs./hr. (1.04 Kg/hr.); the second pass feed rate of the material was 2.8 lbs./hr. (1.27 Kg/hr.).

A spectrophotometer (obtained from Perkin Elmer Lambda, American Fork, Utah, under the trade designation “1050 UV/VIS/NIR”) was used to determine transmission as a function of wavelength for a monolayer of microspheres embedded in the adhesive of a clear packaging tape (obtained from 3M Company, St Paul, Minn., under trade designation “3M SCOTCH HEAVY DUTY PACKAGING TAPE 3850-6”). Bare packaging tape was used as the reference. FIG. 1 shows the effect of changing dopant concentration on wavelength dependent absorbance.

Patch brightness values for EX1 Samples 1-4 were determined using a retroluminometer as described in U.S. Pat. No. 7,513,941 (Frey et. al.). Patch brightness values were determined using a retroluminometer. The device directed white light onto a planar monolayer of microspheres disposed on a white backing material at a fixed entrance angle to the normal of the monolayer. Retroreflective brightness and patch brightness were measured by a photodetector at a fixed divergence angle to the entrance angle (observation angle) in units of (Cd/m2)/lux. Data reported herein were measured at −4° entrance angle and 0.2° observation angle. Retroreflective brightness measurements were made to compare the brightness between beads of different composition. The values were normalized by dividing by a constant factor greater than the highest measured value. Wet retroreflectance values were made on samples with a layer of water with thickness of about 1 millimeter on top of and in contact with the beads.

Retroreflection readings were taken when the beads were placed on a monolayer of TiO₂ pigment-loaded adhesive tape (obtained from 3M Company under trade designation “3M 7000-109-3 (2008) PATCH BRIGHTNESS TAPE 6A-2”). This data is shown in FIG. 2. Wavelength dependent retroreflective data was gathered for these materials using a miniature spectrometer (obtained from Ocean Optics, Dunedin, Fla., under the trade designation “FLAME-S-VIS-NIR-ES”, equipped with a reflectance probe obtained under the trade name “QR400-7-VIS-BX”) observing a spectrum from 400-1000 nm.

The reflectance probe was placed in the spectrometer archway with holes formed in the top of the archway to allow for a 4 or 5 degree entrance angles from normal with a distance of 4.5 inches (11.43 cm) between the probe head and sample. The setup was normalized so that a diffuse white standard (obtained from Ocean Optics under the trade designation “WS-1 REFLECTANCE STANDARD”) was the normalized 100% reflection at all wavelengths.

The retroreflective effect of dopant concentration in the glass base composition is shown in FIG. 3 using the microspheres from Table 3, above. Patches for testing were made in identical fashion as previously described for the retroluminometer measurements.

### Example 2 (EX2)

EX2 beads (Sample 5) were prepared as described for Samples 1-4 in EX1, except that the composition of the starting materials was as shown in Table 5, below.

TABLE 5

| | Sample 5 Slurry, grams |
|---|---|
| CE 1 | 3000 |
| PE 1 | 375.6 |

The resulting beads were either tested as formed (Sample 5A) or tested after further heat treatment (Samples 5B-5F). Heat treatment (HT) was performed in a furnace (obtained from Degussa-Ney Dental Inc., Yucaipa, Calif., under the trade designation “NEY VULCAN 3-550”) by placing the (twice) flame-formed beads into an alumina combustion boat and heating to the disclosed target temperature with a 10° C./min. ramp rate and holding for 1 hour. Heat treated beads were then allowed to cool with the furnace to room temperature. Table 6, below, summarizes the HT data for Samples 5A-5F.

TABLE 6

| Sample ID | Treatment Condition |
|---|---|
| 5A | As Formed |
| 5B | Heat Treat 800° C. |
| 5C | Heat Treat 825° C. |
| 5D | Heat Treat 850° C. |
| 5E | Heat Treat 875° C. |
| 5F | Heat Treat 900° C. |

FIG. 4 shows wavelength dependent retroreflective data for EX2 at different heat treatment temperatures as measured per the description in EX1.

### Example 3 (EX3)

EX3 samples (i.e., Samples 6-9) were prepared using slurry compositions summarized in Table 7, below, using the process described for preparing PE1.

TABLE 7

| Raw Material, grams | Sample 6 | Sample 7 | Sample 8 | Sample 9 |
|---|---|---|---|---|
| TiO₂ | 73.5 | 87.2 | 30.7 | 73.4 |
| Al₂O₃ | 77.4 | 85.1 | 106.0 | 77.3 |
| ZrO₂ | 0.0 | 6.7 | 98.4 | 0.0 |
| SiO₂ | 0.0 | 0.0 | 34.9 | 0.0 |
| Co(OH)₂ | 14.5 | 16.4 | 16.6 | 16.1 |
| MnO₂ | 11.7 | 13.2 | 13.4 | 12.9 |
| Cr₂O₃ | 2.6 | 0.0 | 0.0 | 0.0 |
| CaCO₃ | 32.1 | 0.0 | 0.0 | 32.0 |
| 3MgO•4SiO₂•H₂0 | 41.5 | 57.6 | 0.0 | 41.5 |
| ZrO₂•SiO₂ | 46.8 | 33.8 | 0.0 | 46.8 |
| Total Solids | 300.0 | 300.0 | 300.0 | 300.0 |
| Water | 220.0 | 220.0 | 220.0 | 220.0 |
| Sodium | 6.0 | 6.0 | 6.0 | 6.0 |
| polymethacrylate | | | | |
| solution | | | | |
| Cell gum | 4.5 | 4.5 | 4.5 | 4.5 |

Samples 6-9 were flame formed as described in EX1 using a bench burner (PM2D Model B, obtained from Bethlehem Apparatus Co., Hellertown, Pa.) which produced a fully oxygen-enriched methane flame. The methane flow rate was 7.5 standard liters per minute (SLPM) and the oxygen flow rate was 15 SLPM with 1 SLPM of argon push gas to prevent backfire. Particles were fed through the former at 3 grams/minute for both first and second flame forming passes.

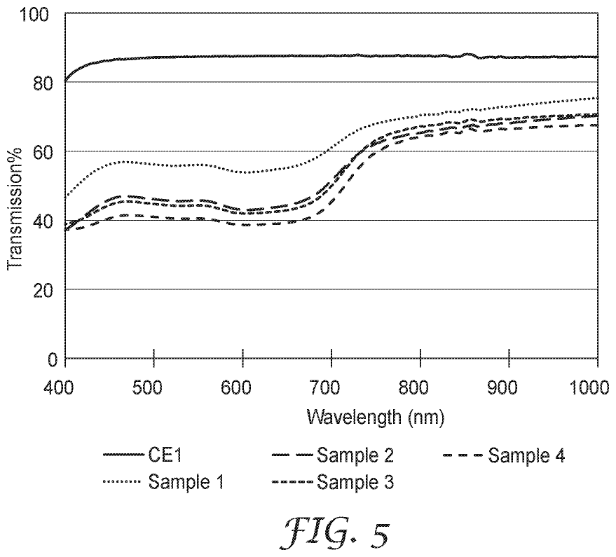

Wavelength dependent retroreflective spectra measurements (shown in FIG. 5) were taken by the same procedure as EX1 on (A) as twice-flame formed microspheres and (B) twice-flame formed microspheres heat treated to 900° C. for 1 hour with 10° C./min. ramp rate and allowed to cool with the furnace as described in EX2.

### Example 4 (EX4)

The EX4 samples (i.e., Samples 10-13) were prepared as described in EX3, except using the slurry compositions listed in Table 8, below.

TABLE 8

| Raw Material, grams | Sample 10 | Sample 11 | Sample 12 | Sample 13 |
|---|---|---|---|---|
| TiO₂ | 157.3 | 155.3 | 168.4 | 178.3 |
| ZrO₂ | 43.5 | 42.4 | 21.0 | 30.1 |
| La₂O₃ | 0.0 | 82.1 | 84.2 | 0.0 |
| SrCO₃ | 0.0 | 0.0 | 0.0 | 16.9 |
| CaCO₃ | 34.9 | 0.0 | 0.0 | 28.1 |
| BaCO₃ | 43.6 | 0.0 | 0.0 | 22.6 |
| Co(OH)₂ | 12.7 | 12.5 | 12.8 | 13.2 |
| MnO₂ | 8.0 | 7.8 | 8.1 | 8.3 |
| ZnO | 0.0 | 0.0 | 5.5 | 2.5 |
| Total Solids | 300.0 | 300.0 | 300.0 | 300.0 |
| Water | 200 | 200 | 200 | 200 |
| Cell gum | 4.5 | 4.5 | 4.5 | 4.5 |
| Sodium | 6.0 | 6.0 | 6.0 | 6.0 |
| polymethacrylate | | | | |
| solution | | | | |

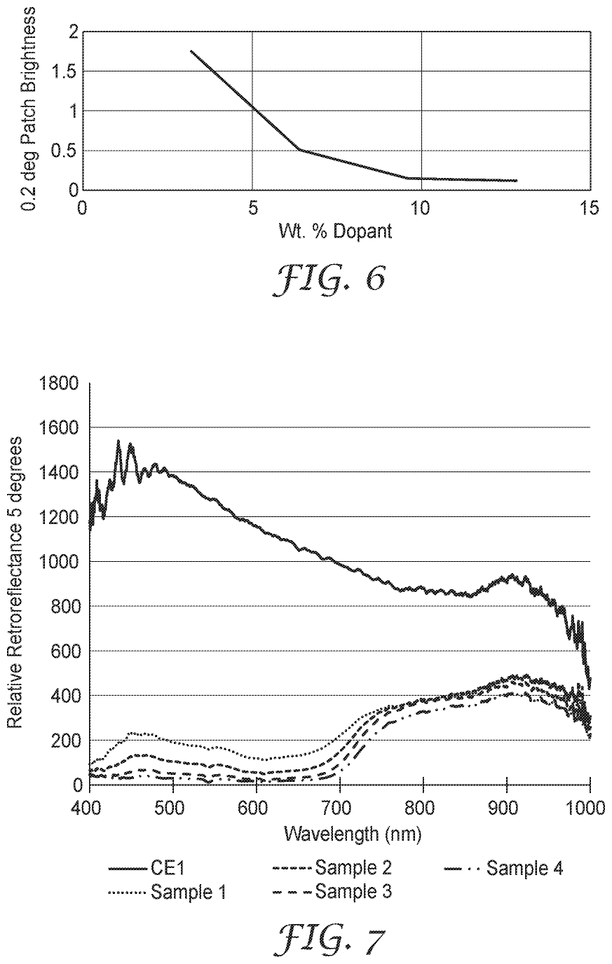

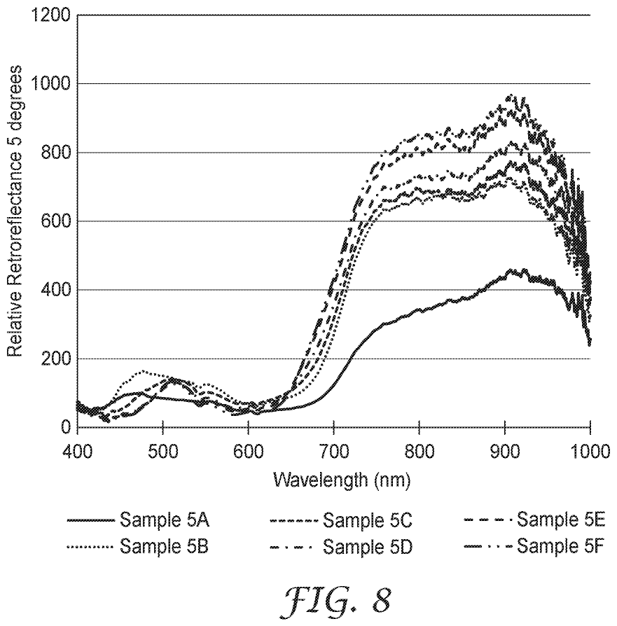

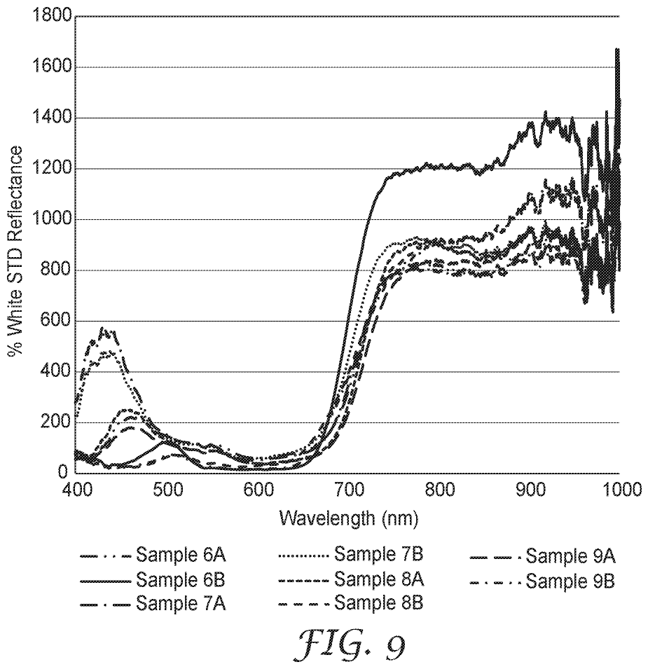

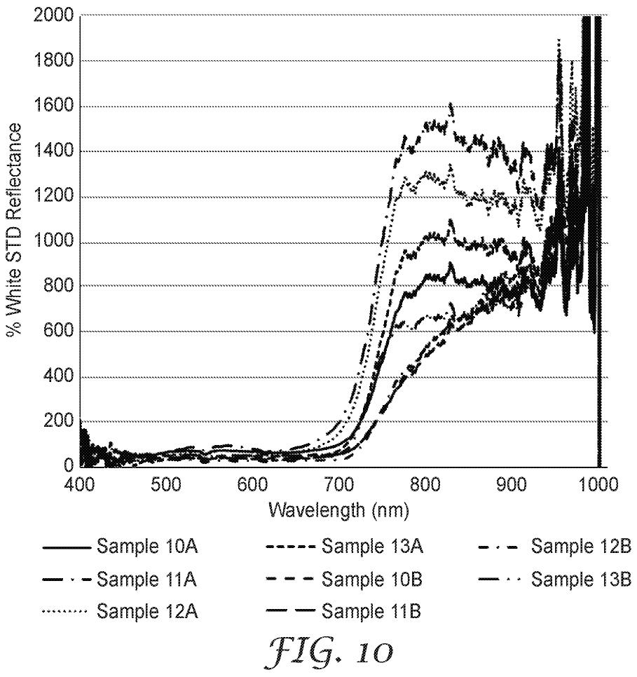

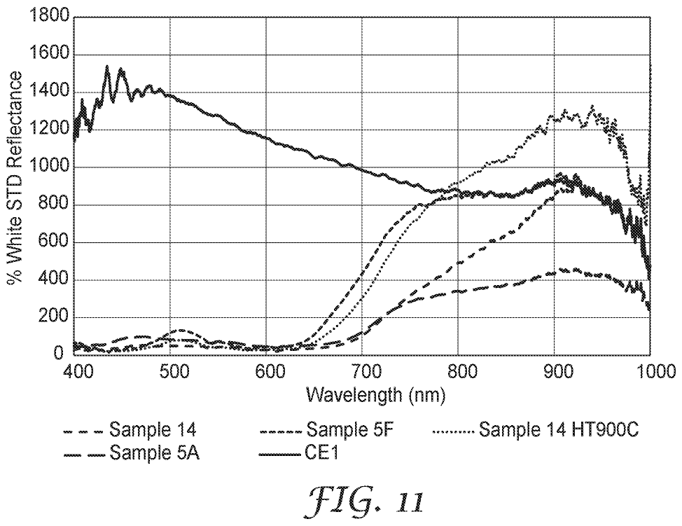

Wet patch retroreflective brightness of EX4 Samples 10-13 (shown in FIG. 6) were obtained as described in EX1, except that the microsphere patches made were covered with 0.5 mL of water over a 0.5 inch (1.25 cm) diameter measurement area.

### Example 5 (EX5)

For EX5 sample (i.e., Sample 14), three-layer stacks of silica and titania coatings were applied to microspheres of Sample 5A (Sample 14) and 5F (Sample 14 HT900C) prepared as described in EX2. Coating apparatus, procedure, and parameters were as follows: 120 grams of beads were placed in a cylindrical 40 mm diameter glass reactor, about 35 cm tall. An oil bath was used to maintain a temperature of 180° C. for titania coating layers. Silica coatings were deposited at ambient temperature (about 22° C.). Nitrogen gas streams were blown through each precursor (SiCl₄ or TiCl₄) bubbler, and directly into the reactor to supplement the total gas flow. Gas flows for each layer type were as follows:
Silica layers: 60 cm³/min. through SiCl₄ bubbler. 1800 cm³/min. through water bubbler. 2000 cm³/min. additional nitrogen flow.
Titania layers: 1200 cm³/min. through TiCl₄ bubbler. 1300 cm³/min. through water bubbler. 1000 cm³/min. additional nitrogen flow.
A three-layer (silica-titania-silica) coating stack designed for maximum near-IR retroreflection was deposited. 170 nm thick silica coating with a refractive index of n˜1.4 and 108 nm thick titania coating with a refractive index of n˜2.2 were formed corresponding to quarter wave thicknesses for 950 nm. Coating times were 45 minutes for each silica layer and 32 minutes for the titania layer.

Wavelength dependent retroreflective spectra measurements (shown in FIG. 7) for Sample 14 and Sample 14 HT900C were taken by the same procedure as described in EX1. FIG. 7 also shows wavelength dependent retroreflective spectra of EX2 Samples 5A and 5F, as well as CE1 as a reference.

### Example 6

EX6 sample (i.e., Sample 15) was prepared in the same manner as described for EX2, except the composition of the slurry used was as shown in Table 9, below.

TABLE 9

| Raw Material | Amount, grams |
|---|---|
| TiO₂ | 713.6 |
| Al₂O₃ | 751.9 |
| CaCO₃ | 432.0 |
| Co(OH)₂ | 161.9 |
| MnO₂ | 101.3 |
| Talc | 369.1 |
| Zircon | 470.3 |
| Water | 1850.0 |
| Sodium | 60.0 |
| polymethacrylate | |
| solution | |
| Cell gum | 45.0 |

The crush strength of the resulting as-formed and heat-treated Sample 15 was determined as follows. Crush resistance of microspheres was measured on an apparatus having parallel plates made of very hard, non-deforming material (1 cm diameter cylindrical sapphire). A single microsphere of known diameter was placed on the lower plate and the upper plate loaded with increasing force until the microsphere failed. Crush resistance is the force exerted on the microsphere at failure divided by the cross-sectional area of the microspheres (πr2). Ten microspheres of a given composition are tested and the average result reported as the crush resistance for the composition. The results are summarized in Table 10, below.

TABLE 10

| Sample | Crush Strength, MPa |
|---|---|
| Sample 15 As Formed | 829 |
| Sample 15 Heat treated at 850° C. | 666 |
| Sample 15 Heat treated at 950° C. | 612 |

Foreseeable modifications and alterations of this disclosure will be apparent to those skilled in the art without departing from the scope and spirit of this invention. This invention should not be restricted to the embodiments that are set forth in this application for illustrative purposes.

1. A plurality of nanocrystalline ceramic oxide beads, wherein the nanocrystalline ceramic oxide beads have an average crystallite size up to 250 nm, wherein each bead collectively comprises, on a theoretical oxides basis, at least 40 weight percent of at least one of Al₂O₃, SiO₂, TiO₂, or ZrO₂, and at least 1 weight percent of at least one of a transition metal oxide or at least one of Bi₂O₃ or CeO₂, based on the total weight of the nanocrystalline ceramic oxide beads, and are visibly dark and infrared transmissive.

2. The plurality of nanocrystalline ceramic oxide beads of claim 1 collectively comprising, on a theoretical oxides basis, at least 80 percent by weight SiO₂ and ZrO₂, based on the total weight of the nanocrystalline ceramic oxide beads.

3. The plurality of nanocrystalline ceramic oxide beads of claim 1 collectively comprising, on a theoretical oxides basis, at least 80 percent by weight Al₂O₃, SiO₂, and ZrO₂, based on the total weight of the nanocrystalline ceramic oxide beads.

4. The plurality of nanocrystalline ceramic oxide beads of claim 1 collectively comprising, on a theoretical oxides basis, at least 70 percent weight Al₂O₃, SiO₂, TiO₂, and ZrO₂, based on the total weight of the nanocrystalline ceramic oxide beads.

5. The plurality of nanocrystalline ceramic oxide beads of claim 1 collectively comprising, on a theoretical oxides basis, at least 60 percent by weight TiO₂ and ZrO₂, based on the total weight of the nanocrystalline ceramic oxide beads.

6. The nanocrystalline ceramic oxide beads of claim 1 collectively comprising, on a theoretical oxides basis, at least 60 percent by weight TiO₂, based on the total weight of the nanocrystalline ceramic oxide beads.

7. (canceled)

8. The plurality of nanocrystalline ceramic oxide beads of claim 1, further collectively comprising, on a theoretical oxides basis, at least 5 percent by La₂O₃, based on the total weight of the nanocrystalline ceramic oxide beads.

9. (canceled)

10. The plurality of nanocrystalline ceramic oxide beads of claim 1, wherein the beads have an average crush strength of at least 200 MPa.

11. The plurality of nanocrystalline ceramic oxide beads of claim 1, wherein the beads have a refractive index at 900 nm of at least 1.6.

12. (canceled)

13. A plurality of coated beads comprising the nanocrystalline ceramic oxide beads of claim 1, wherein the nanocrystalline ceramic oxide beads have an outer surface with at least one layer of a ceramic oxide thereon.

14-15. (canceled)

16. The plurality of coated beads of claim 13, wherein the layer of ceramic oxide has an average thickness that is within ±30% of an optical ¼ wave coating for 900 nm light.

17. (canceled)

18. An article comprising the plurality of beads of claim 1.

19-21. (canceled)

22. The article of claim 18, wherein at least a portion of the plurality of beads is arranged to exhibit at least one barcode.

23-24. (canceled)

25. A paint layer having a dark major surface, the paint layer comprising a plurality of beads of claim 1, wherein the dark major surface has a retroreflectivity at 900 nm that is at least twice that of the same surface without the plurality of beads being present.

26. A film having a dark major surface, the film layer comprising a plurality of beads of claim 1, wherein the dark major surface has a retroreflectivity at 900 nm that is at least twice that the same surface without the plurality of beads being present.

27. A method of making the nanocrystalline ceramic oxide beads of claim 1, the method comprising flame heating green ceramic particles to provide the plurality of nanocrystalline ceramic oxide beads.

28. The method of claim 27, further comprising heat treating the plurality of nanocrystalline ceramic oxide beads.

29. A method of making the nanocrystalline ceramic oxide beads of claim 1, the method comprising:
forming particles from a sol gel to provide formed particles;
calcining the formed particles to provide calcined particles; and
sintering the calcined particles to provide the plurality of nanocrystalline ceramic oxide beads.

30. The method of claim 29, further comprising heat treating the plurality of nanocrystalline ceramic oxide beads.
